(19) United States
(12) Patent Application Publication
(10) Pub. No.: US 2019/0001906 A1
(43) Pub. Date: Jan. 3, 2019

(54) METHOD AND APPARATUS FOR DYNAMIC CONFIGURABLE VEHICLE OCCUPANT QUERIES

(71) Applicant: FORD GLOBAL TECHNOLOGIES, LLC, Dearborn, MI (US)

(72) Inventors: Mark Anthony Rockwell, Wyandotte, MI (US); Benjamin M. Rocci, Plymouth, MI (US); David Randolph Roberts, Dearborn, MI (US)

(21) Appl. No.: 15/639,103

(22) Filed: Jun. 30, 2017

(51) Int. Cl. B60R 16/037; G10L 15/26; G07C 5/08

(52) U.S. Cl. CPC B60R 16/0373; G10L 15/00; G07C 5/085; G10L 15/265

(57) ABSTRACT

A system includes a processor configured to receive an input question relating to a vehicle-detectable vehicle issue. The processor is also configured to determine a parameter, the occurrence of which indicates the possible existence of the vehicle-issue. The processor is further configured to determine a vehicle-system in which the vehicle issue occurs. The processor is additionally configured to identify a plurality of individual vehicles including the vehicle-system in their respective configurations. The processor is also configured to compile a query including the question, parameter and vehicle-system and wirelessly distribute the query to the identified vehicles

### TECHNICAL FIELD

The illustrative embodiments generally relate to methods and apparatuses for dynamic configurable vehicle occupant queries.

### BACKGROUND

Many modern vehicles include advanced computing functionality, such as on-board telematics providing remote connectivity, streaming music and video, navigation functionality and even on-board Internet access. Connectivity makes vehicle quality data increasingly available and provides an opportunity for upload of vehicular data for remote analysis. This data is often very technical in nature and does not typically include customer feedback. Also, the data is usually gathered in a fixed fashion (e.g., based on a set of fixed, defined parameters, such as “report fuel efficiency every 100 miles”).

While data reported from vehicles in a consistent fashion provides a variety of useful information for original equipment manufacturers (OEMs), there is often a need to perform significant analysis and sorting in order to isolate data related to specific incidents. Also, since there is not commonly occupant feedback included with the data, it can be difficult to determine certain otherwise unknown variables and actions that may affect a condition that occurred around the time of data gathering. This can make attempts to tie the data to a particular condition difficult.

On the other hand, consistently querying occupants as to their ongoing activities could represent a fairly annoying practice for customers. Not only could it distract a driver, but the customers would largely almost immediately disable a feature that caused a vehicle to present an ongoing stream of queries related to continued activity.

### SUMMARY

In a first illustrative embodiment, a system includes a processor configured to receive an input question relating to a vehicle-detectable vehicle issue. The processor is also configured to determine a parameter, the occurrence of which indicates the possible existence of the vehicle-issue. The processor is further configured to determine a vehicle-system in which the vehicle issue occurs. The processor is additionally configured to identify a plurality of individual vehicles including the vehicle-system in their respective configurations. The processor is also configured to compile a query including the question, parameter and vehicle-system and wirelessly distribute the query to the identified vehicles.

In a second illustrative embodiment, a system includes a processor configured to receive a query including a vehicle-detectable parameter and value. The processor is also configured to monitor a system corresponding to the vehicle-detectable parameter for the occurrence of the value. The processor is additionally configured to present the query to a vehicle occupant, responsive to the occurrence of the value. The processor is further configured to receive a response to the query and wirelessly transmit the response to a remote server from which the query originated.

In a third illustrative embodiment, a system includes a mobile device processor configured to receive a query from a remote server, including at least one question for a device-possessor. The system also includes a vehicle-processor configured to receive a data-gathering instruction from the remote server, including a vehicle detectable parameter and value and identification of desired data. The vehicle-processor is further configured to monitor a system corresponding to the vehicle-detectable parameter for the occurrence of the value and, responsive to the occurrence of the value, both gather the identified desired data and send an instruction to the mobile device processor to present the question. The vehicle-processor is also configured to transmit the gathered data to a remote server, and the mobile device processor is configured to present the question, responsive to receipt of the instruction and transmit a response to the question.

### BRIEF DESCRIPTION OF THE DRAWINGS

FIG. 1 shows an illustrative vehicle computing system;

FIG. 2 shows an illustrative process for query configuration;

FIG. 3 shows an illustrative process for query presentation; and

FIG. 4 shows an illustrative query-handling system and process flow.

### DETAILED DESCRIPTION

As required, detailed embodiments are disclosed herein; however, it is to be understood that the disclosed embodiments are merely illustrative and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

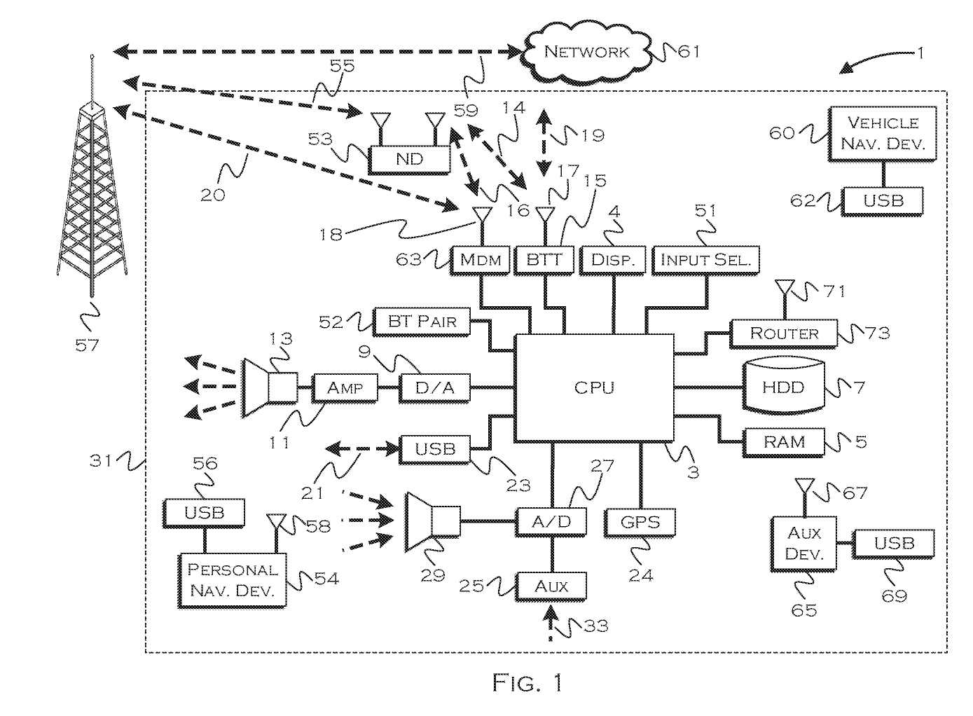

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a Wi-Fi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include Wi-Fi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., Wi-Fi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a Wi-Fi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

While it is very useful to gather technical vehicle data in an ongoing sense, it is often an occupant action or other occupant-observable (but not vehicle sensor-registerable) occurrence that may be of pertinence to a particular observed vehicle condition. While it might be possible to include a vast array of sensing capability in a vehicle to determine many factors of occupant action, such technology could be prohibitively expensive, and may be simply replaced by asking a simple question of an occupant about a present or recent action.

Even if customers might be annoyed by an ongoing and endless stream of questions about actions, a periodic question (once every month, for example) might be better received. If customers understand that they are helping contribute to an improved vehicle experience, they may be willing to occasionally assist an OEM in better understanding the root cause of a particular issue. And, in some instances, it may even be possible to provide the customer with an incentive to answer the question, such as an oil-change discount or similar incentive. If the questions are intermittent and infrequent, such an incentive would not be overly expensive for the provider, and may seem to both parties to be a fair exchange for the customer's assistance. Even in the absence of incentive, however, the ability to improve the overall ride, safety and repair-free experience may be incentive enough for many people to occasionally assist by answering a question or two.

Accordingly, the illustrative embodiments provide examples of a system and process for allowing OEM engineers to define particular conditions-of-interest, such as a particular diagnostic event, and to issue a query of customers experiencing the diagnostic event, in order to better pin down the cause of a problem.

For example, if a telematics system that also provided hands-free calling were to rarely, but occasionally, freeze up and fail to hang-up a phone call, it may be very difficult to find a correspondence between vehicle data and the root cause of the event. But, if a diagnostic event were to include, for example, receiving presses of an “end call” button more than 10 times in 30 seconds, and/or the persistence of a call despite the button presses, OEMs could identify this condition and possibly determine certain actions that caused the failure. So, under the illustrative embodiments, the OEMs could ask open-ended or closed ended questions (depending on how close to a root-cause the engineers were) and possibly narrow down the causes to a customer action, allowing for programming to avoid the problem in the future.

In this example, assume that turning the radio power off while the call was in progress was the actual cause. The questions could begin in an open form, such as “while you were on the recent call that did not end, do you recall interacting with any vehicle system controls? If so, what controls did you use?” After some number of questions revealed that the bulk of customers experiencing the problem interacted with a radio control (which would be the case if that was the actual and only cause of the problem), the questions could become more refined. Such as “Did you interact with a radio station control? Did you interact with a radio power control?” etc. This line of questioning may soon reveal that the radio power control was the root cause of the problem. Since that may not be data that is typically reported, it may have been very difficult to discover the cause of the problem without customer feedback, but once the problem cause is known the engineers may be able to quickly zero-in on a solution.

In a similar manner, customer feedback can be gathered. If certain high-cost features that are optional in a number of vehicles are also commonly unused, for example, marketing or product design teams can develop several simple questions that could target the reason for disuse. For example, if a moon-roof option were only used 1 out of every 50 drives, the team could determine what the top causes for dis-use were. If these causes were: 1) the controls require the driver to remove their hands from the wheel; and 2) weather, the team could decide whether or not to address the first cause by placing a control on the wheel. The team could even issue a questionnaire to determine if control relocation would be likely to result in higher use.

Before the cause was known, the team may, using the illustrative embodiments, issue the questionnaire to everyone who had a moon-roof, or to everyone who had a moon roof that did not use it more than a threshold amount. This already provides significant zeroing in on the target demographic, and would avoid unnecessary questioning of a larger, less relevant demographic.

Once the top two causes were known, the second question (“would you use the moon-roof more frequently if the control were on the wheel?”) could be issued to the people who responded with an answer relating to control location. Again, this is a small subset, but highly representative of a target demographic. With a reasonable sample size, the design team could then make an educated decision about adding the control feature to the vehicle wheel.

By allowing for highly configurable questions that are directable to a highly relevant subset representing a particular issue-of-interest, the illustrative embodiments provide an opportunity to receive pointed customer feedback in a very non-intrusive and unburdensome manner. It would even be possible, for example, to set a cap on a particular user or vehicle, so that a defined limit of questions were asked over a defined time period (thus essentially ensuring that no customer felt that the OEM was bothering them overmuch). Vehicles over the cap could be exempted from some or all of future questions until the time period expired. On the other hand, certain customers may be very interested in providing feedback on all matters, and thus could “opt-in” to various questions that may not even be relevant to their particular vehicle. This would be useful in the moon-roof example above, if the question were along the lines of “would you be more likely to purchase a vehicle including a moon-roof if the control were on the wheel,” but probably not very useful when it came to diagnosing the cause of a particular experienced problem (because the opt-in customer would not have necessarily experienced the problem).

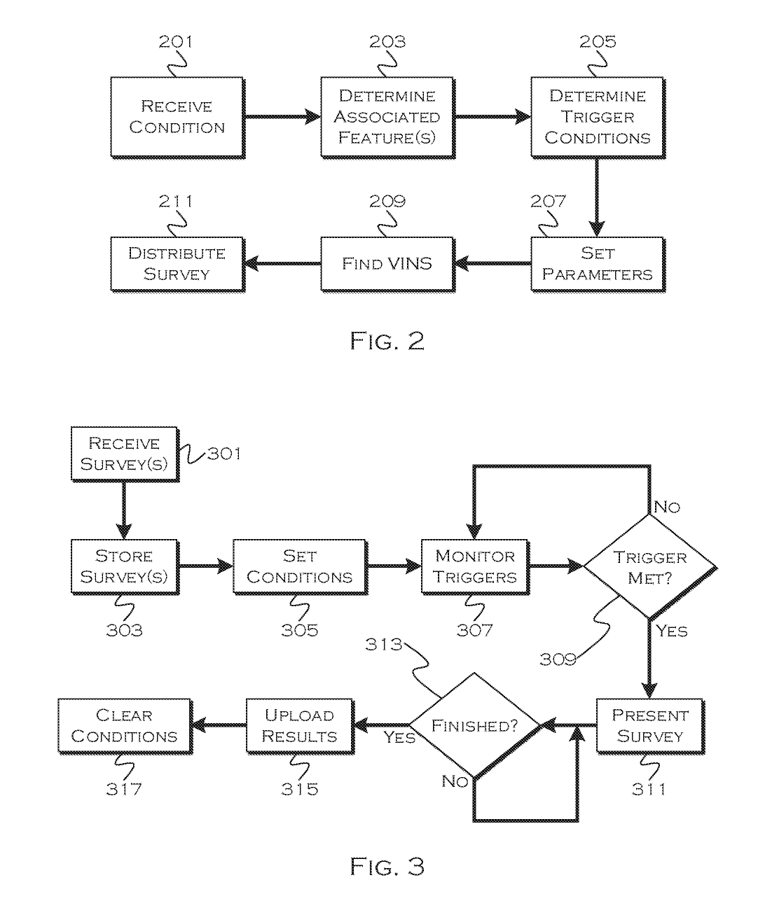

FIG. 2 shows an illustrative process for query configuration. In this example, the process receives 201 a condition definition at a server responsible for eventually distributing a query to a variety of customer vehicles. Since these questions will not typically go to every vehicle, the process may also determine 203 or receive associated features that relate to the condition. For example, using the failure to disconnect example, the process may determine that hands-free calling and telematics functions were features associated with the condition “call does not end when requested.”

The process may also determine 205 or receive a set of trigger conditions, which can be, for example, pressing a button 10 times in 30 seconds with no disconnect, and call does not end when requested. The process then sets 207 parameters for query distribution, which can be based on vehicles including some or all of the identified features. In this case, the process would set the query to be distributed to all connected vehicles including telematics and hands-free calling. This would prevent the survey from being distributed to vehicles which are unlikely candidate vehicles, which, in this instance, would largely simply preserve memory and bandwidth (since those vehicles will also not likely experience the trigger conditions, even if they received the survey).

In another example, the problem may not even be defined enough for the system or engineers to define a trigger condition set, so the process could be distributing questions of the type “have you ever experienced a call failing to disconnect?” In this case, it would be more useful to avoid the non-telematics or non-hands-free vehicles, since those customers would not have possibly experienced the problem (at least in those vehicles) and would not care to answer the question or could not answer the question in any manner other than “no,” if being truthful.

Once the distribution parameters are set, the process can find 209 the VINs or other vehicle identifiers relating to all vehicles having the features defined by the parameters. This can be done through reference to a database, for example. The process can then distribute 211 the questions to the identified vehicles in a defined manner.

Customer opt-outs, over-query flags and other reasons not to distribute to a particular vehicle can also be stored in the database, or they can be stored locally on the vehicle. In the former case, the process can ignore the VINs of such customer vehicles, in the latter case the vehicle itself can simply ignore the question (or save the question until such time as the lockout period, if one exists, expires). When a question is saved, it could have an expiration period associated therewith, or could be open-ended and discarded upon command (such as when the engineers have fixed the problem). In the latter case, a separate command to discard a certain query could be sent to all vehicles in an identified subset that have not yet responded to a particular query, using similar sorting techniques to those used to send the question(s) in the first place.

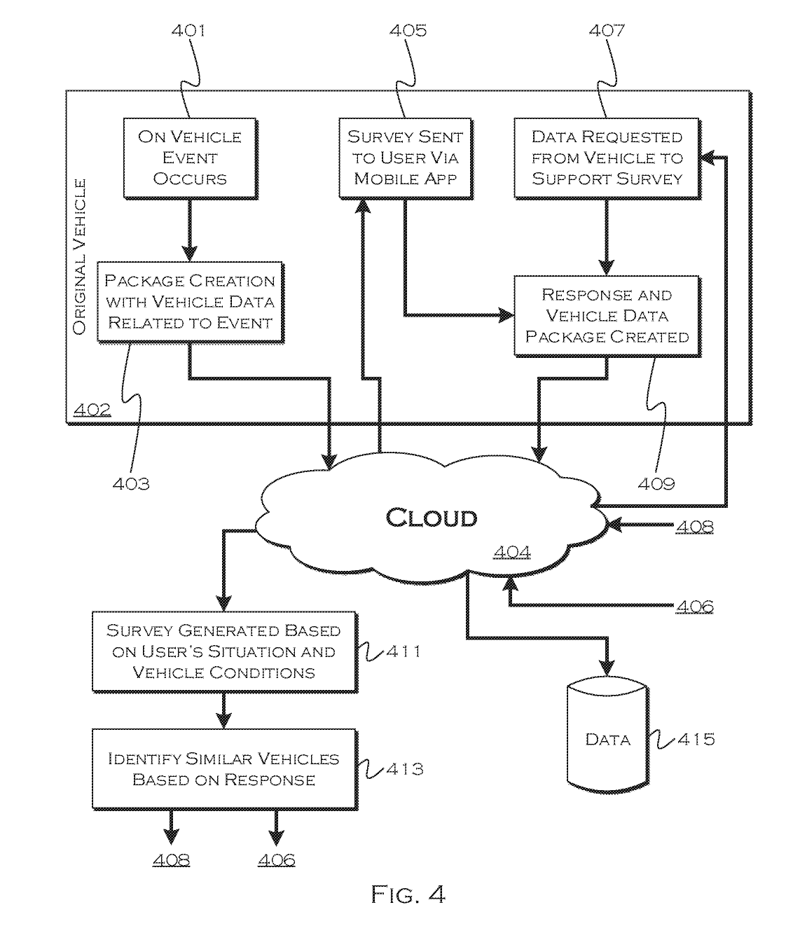

FIG. 3 shows an illustrative process for query presentation. In this example, the process executing on a vehicle receives 301 a query directed to that vehicle, typically for a reason related to a feature included in the vehicle, or even possibly a known customer-attribute (such as a known demographic—e.g., age, sex, etc).

When the question is not an immediate one, but rather relates to a particular triggered condition (such as a vehicle diagnostic code or event) the process can store 303 the query. The process can then set 305 a series of conditions defined by the query, which could include, using the previous non-limiting calling example, waiting for a series of “end call” button presses while a call fails to end responsively. The process then monitors 307 the appropriate vehicle inputs, systems, etc. until the defined trigger(s) are met 309. In this example, the triggers would be both the button presses and the failure of the call to end.

Once the conditions are met, the process presents 311 the query in the vehicle, or waits until an appropriate time to present the query. Waiting could be contingent on a variety of factors, although in some cases at least it would be better to present the question sooner rather than later. In certain instances, such as this one, the process could even “fix” the problem (e.g. include code to force the call to end), which would likely please the customer and give them more reason to both participate in the process in general and answer the question as a “thank you” for the current fix. The answers could be given verbally and later converted into text if desired, or yes/no questions could be answered via an interface if it were deemed safe to do so.

Once the query is finished 313, the process can upload 315 the customer answers to a remote database, where engineers can sift through the answers to determine the cause of identified problems, for example. The process then also clears 317 the condition checks, to avoid re-asking the customer the same question. In one example, to the extent that there is a “force fix” associated with the problem, the condition checks could persist and the force fix could be executed in the absence of the questionnaire, as a reward to customers for previously completing the question/answer process. This could persist until such time as a real fix were implemented in the software, for example.

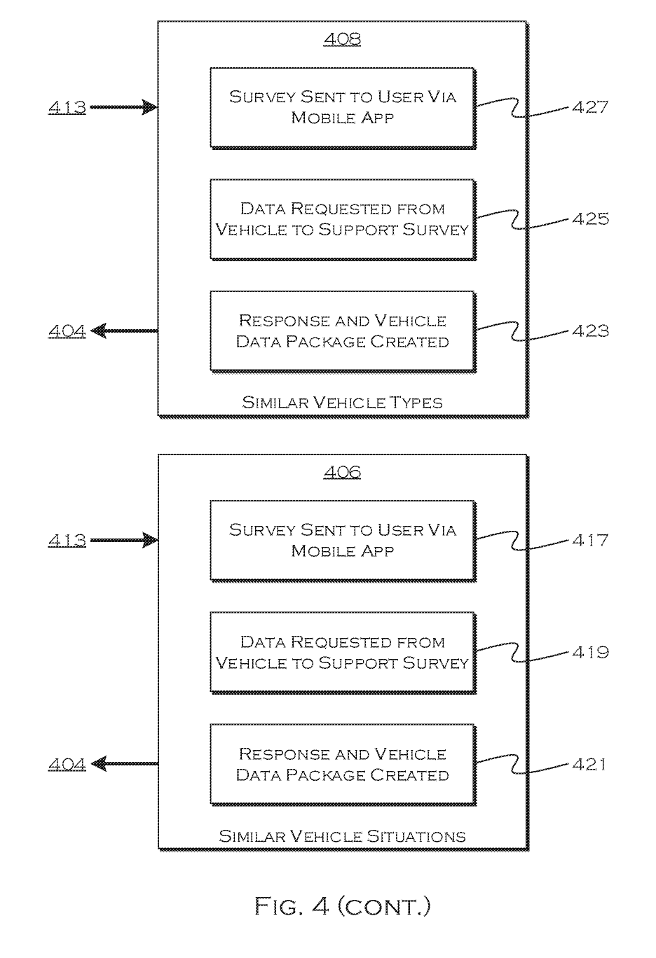

FIG. 4 shows an illustrative query-handling system and process flow. In this example, a certain event or diagnostic code occurs 401 in an object vehicle and is the basis for the dynamic creation of a survey. In this example, once the event/code occurs 401, the process responsively gathers 403 a potentially large set of vehicle data (such as data that may not be commonly otherwise gathered) and sends that data to a cloud 404 sever. If the condition is survey-worthy (e.g., it does not appear to be a one-off event), which can be determined, for example, by accruing instances of the code/event until a threshold is reached, the process may identify 413 vehicles including similar features (configurations, system options, models, etc) and/or experiencing similar driving situations (inclement weather, night driving, etc). The degree of specificity of identification of similar vehicles may be tailored based on how much is currently known about the root cause of an event.

For example, the first iteration of events (first 1000 times, for example) may result in all vehicles having any remote connectivity capability being queried (using the preceding disconnect example). The second iteration may result in vehicles including telematics functions and hands-free calling, which could be related systems identified through the issuance of the first query responsive to the first iteration. That is, upon the second time 1000 events were reported, a refined query could be sent that did not go to all vehicles included in the first query, which would serve to refine the response group. The system can draw the vehicle identification, configuration and even current-driving situation data from one or more databases 415 associated with the cloud server forming the query.

In this example, the queries are sent to user mobile devices 406, 408, the user mobile device being associated with a vehicle owner or driver, and stored in an owner/driver profile, for example. The device could also represent any device presently connected to the vehicle-of-interest for each identified similar vehicle. As an alternative to sending the query to the vehicle, sending the query to the mobile device allows the user to answer the query at a later time, which may be more convenient. On the other hand, this may also result in a lower likelihood of the user remembering what they were doing at the time the event occurred. If the query is a triggered query, the mobile device may not present the query unless the trigger(s) occur (the vehicle or the cloud could indicate this to the mobile device). Alternatively, the query could lead with a question of the form “have you ever experienced X,” which could avoid having to wait for X to occur or the triggers associated with X to occur.

The process sends the survey to a mobile application 427/417 (same vehicle type/same vehicle situation) and the process also requests data 425/419 from the vehicle that may support the query. The data request could come from the mobile device (if connected to the vehicle) or from the cloud directly. The vehicle and/or mobile device then packages any responsive data 423/421 and sends the relevant data (vehicle data, query answers) back to the cloud.

It is worth noting that the query and vehicle data do not necessarily need to be answered in conjunction. For example, the cloud could request certain data from the vehicle if a triggered event occurred, and at the same time query the mobile device for user-response, with a question such as “have you ever experienced X?” The vehicle can wait for the event to occur, if appropriate, and respond with requested data, while the user can answer the query immediately if desired, such that as much relevant data as possible is gathered without either gathering event having to wait for the other.

The query(s) are also sent to the vehicle(s) 402 involved in detecting the problem in a similar manner. A query can be sent 405 to a driver/user mobile device and sent 407 to the vehicle directly for additional data as needed or desired. In this instance, there is an assurance that the driver experienced the issue at least once (as the issue was the basis for the query formulation), although depending on the issue the driver may not have realized the problem occurred. As with the other queries, the answers can be sent 409 back to the cloud individually or packaged together.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined in logical manners to produce situationally suitable variations of embodiments described herein.

1. A system comprising:
a processor configured to:
receive an input driver-answerable question relating to a vehicle-detectable vehicle issue;
determine a parameter, an occurrence of which indicates a possible existence of the vehicle-issue;
determine a vehicle-system in which the vehicle issue occurs;
identify a plurality of individual vehicles including the vehicle-system in their respective configurations;
compile a query including the question, parameter and vehicle-system; and
wirelessly distribute the query to the identified vehicles.

2. The system of claim 1, wherein the parameter includes a diagnostic trouble code.

3. The system of claim 1, wherein the parameter includes a specific signal detectable on a vehicle BUS.

4. The system of claim 1, wherein the parameter includes a state detectable by a vehicle sensor.

5. The system of claim 1, wherein the input question also includes express identification of the vehicle-system.

6. The system of claim 1, wherein the input question also includes express identification of the parameter.

7. The system of claim 1, wherein the processor is configured to access a database storing vehicle configurations for individual vehicles in order to identify the plurality of vehicles.

8. The system of claim 7, wherein the database includes identifying information allowing for direct communication with individual vehicles.

9. The system of claim 1, wherein the processor is configured to:
wirelessly receive a response to the query from an individual vehicle; and
update a vehicle data record corresponding to the individual vehicle to indicate that the vehicle has previously responded to the input question.

10. A system comprising:
a processor configured to:
receive a query including a vehicle-detectable parameter and parameter value indicating a state-of-interest to a querent;
monitor a system corresponding to the vehicle-detectable parameter for an occurrence of the value;
responsive to the occurrence of the value, present the query to a vehicle occupant;
receive a response to the query; and
wirelessly transmit the response to a remote server from which the query originated.

11. The system of claim 10, wherein the vehicle-detectable parameter includes diagnostic trouble codes and the value includes a specific diagnostic trouble code.

12. The system of claim 10, wherein the vehicle-detectable parameter includes a signal on a vehicle BUS and the value includes a signal value or range.

13. The system of claim 10, wherein the vehicle-detectable parameter includes a vehicle sensor and the value includes a state detectable by the vehicle sensor.

14. The system of claim 10, wherein the processor is configured to present the query by sending the query to a mobile device associated with a vehicle occupant.

15. The system of claim 14, wherein the processor is configured to receive the response to the query from the mobile device.

16. A system comprising:
a mobile device processor configured to:
receive a query from a remote server, including at least one question for a device-possessor; and
a vehicle-processor configured to:
receive a data-gathering instruction from the remote server, including a vehicle detectable parameter and value and identification of desired data;
monitor a system corresponding to the vehicle-detectable parameter for an occurrence of the value;
responsive to the occurrence of the value, both gather the identified desired data and send an instruction to the mobile device processor to present the question; and
transmit the gathered data to a remote server,
wherein the mobile device processor is configured to present the question, responsive to receipt of the instruction; and
transmit a response to the question.

17. The system of claim 16, wherein the vehicle-detectable parameter includes diagnostic trouble codes and the value includes a specific diagnostic trouble code.

18. The system of claim 16, wherein the vehicle-detectable parameter includes a signal on a vehicle BUS and the value includes a signal value or range.

19. The system of claim 16, wherein the vehicle-detectable parameter includes a vehicle sensor and the value includes a state detectable by the vehicle sensor.

20. The system of claim 16, wherein the mobile device processor is configured to transmit the response to the question to the vehicle-processor, and wherein the vehicle processor is configured to include the response to the question with the transmitted gathered data.
